(19) United States
(12) Patent Application Publication
(10) Pub. No.: US 2018/0112686 A1
(43) Pub. Date: Apr. 26, 2018

(54) HYDRAULIC ACTUATOR SYSTEM OF VEHICLE HAVING SECONDARY LOAD-HOLDING VALVE WITH TANK CONNECTION

(71) Applicant: HydraForce, Inc., Lincolnshire, IL (US)

(72) Inventor: Damiano Roberti, Roma (IT)

(21) Appl. No.: 15/792,382

(22) Filed: Oct. 24, 2017

Related U.S. Application Data
(60) Provisional application No. 62/413,290, filed on Oct. 26, 2016.

(51) Int. Cl. F15B 13/06; E02F 9/22; E02F 9/08; F15B 11/16

(52) U.S. Cl. CPC F15B 13/06; E02F 9/2271; E02F 9/2267; E02F 9/2225; F15B 1/26; F15B 11/16; F15B 2211/30525; F15B 2211/31523; E02F 9/0883

(57) ABSTRACT

A hydraulic actuator control system includes a secondary manifold that is configured to direct a meter-in flow received from a main directional valve to the actuator and to direct a meter-out flow of fluid received from the actuator directly to a tank without the return flow travelling back through the main directional valve. The hydraulic actuator control system has a separate return flow connection that permits the use of a load-holding valve (such as, e.g., counterbalance valves, motion control valves, pilot-operated check valves, or zero-leakage logic elements) flanged on the machine's actuator (such as, e.g., a linear cylinder, a rotary cylinder, or a hydraulic motor) to create a directional control valve without directing the return flow through the main directional control valve.

### CROSS-REFERENCE TO RELATED APPLICATIONS

This patent application claims the benefit of priority to U.S. Provisional Patent Application No. 62/413,290, filed Oct. 26, 2016, and entitled, “Hydraulic Actuator Control System of Vehicle Having Secondary Load-Holding Valve with Tank Connection,” which is incorporated in its entirety herein by this reference.

### TECHNICAL FIELD

This patent disclosure relates generally to a hydraulic actuator system and, more particularly, to a hydraulic actuator control system where a combination of valves is used to control the movement of an actuator of a vehicle.

### BACKGROUND

Vehicles, such as, telehandlers, backhoe loaders, wheel loaders, tractors, excavators, etc., can include one or more actuators configured to selectively manipulate an implement. Typically, such an actuator is a hydraulic actuator that is controlled via a hydraulic actuator control system The hydraulic actuator control system can include a combination of valves used to control the movement (e.g., over a reciprocal linear extend/retract range of travel or a rotational clockwise/counterclockwise range of travel) of a hydraulic actuator of the vehicle.

Various systems have been used before to act as the hydraulic actuator control system. For example, a flow directional control valve in a spool type arrangement can be connected to load-holding valves. Other known systems use two proportional valves (or on/off solenoid valves) in combination with logic elements or load-holding valves, for example, to control a double-acting cylinder or hydraulic motor. In these arrangements, the system includes the combination of a main component/system designated to control the flow direction and a secondary valve designated to hold the actuator in a set position. The secondary load-holding valve is connected between the main component/system and the actuator and directs the return flow from the actuator back to the main component/system.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one aspect, is directed to embodiments of a hydraulic actuator system in which a return flow from one or more actuators is conveyed through a secondary valve to a tank without flowing through a main directional control valve. In one embodiment, a hydraulic actuator system includes a tank, a pump, a main directional control valve, a secondary valve, and an actuator.

The tank is adapted to hold a reservoir of fluid. The pump is in fluid communication with the tank. The pump is adapted to receive a supply of fluid from the tank and to discharge a meter-in flow of fluid.

The main directional control valve is in fluid communication with the pump and the secondary valve such that the main directional control valve is interposed therebetween. The main directional control valve is adapted to selectively direct the meter-in flow of fluid from the pump to the secondary valve.

The secondary valve is in fluid communication with the main directional control valve and the actuator such that the secondary valve is interposed between the main directional control valve and the actuator. The secondary valve is adapted to direct the meter-in flow of fluid from the main directional control valve to the actuator. The secondary valve is in fluid communication with the actuator and the tank such that the secondary valve is interposed between the actuator and the tank. The secondary valve is adapted to receive a meter-out flow of fluid from the actuator and to direct the meter-out flow of fluid to the tank. The fluid communication of the secondary valve with the tank being configured such that the meter-out flow of fluid from the actuator is communicated through the secondary valve to the tank without passing through the main directional control valve.

In another aspect, embodiments of a method of controlling a hydraulic actuator are disclosed. In one embodiment, a method of controlling a hydraulic actuator includes conveying a meter-in flow of fluid from a supply of fluid in a tank to a main directional control valve. The meter-in flow of fluid is selectively directed from the main directional control valve to a secondary valve. The meter-in flow of fluid is directed from the secondary valve to the hydraulic actuator. A meter-out flow of fluid is directed from the hydraulic actuator to the secondary valve. The meter-out flow of fluid is directed from the secondary valve to the tank via a return flow path without passing through the main directional control valve.

Further and alternative aspects and features of the disclosed principles will be appreciated from the following detailed description and the accompanying drawings. As will be appreciated, the hydraulic actuator systems, control arrangements, and methods disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic view of an embodiment of a hydraulic circuit in accordance with principles of the present disclosure, the hydraulic circuit including a main/central valve adapted for use in directing a meter-in flow to a pair of actuators by way of a corresponding pair of secondary valves adapted for use in providing, respectively, a load-holding function and directing a meter-out return flow from the actuators to a tank.

FIG. 2 is a schematic view of another embodiment of a hydraulic circuit in accordance with principles of the present disclosure, the hydraulic circuit including a half bridge system adapted to provide a load sense system and a flow sharing feature.

FIG. 3 is a schematic view of another embodiment of a hydraulic circuit in accordance with principles of the present disclosure, the hydraulic circuit including a half bridge system adapted to provide a load sense system and a flow sharing feature where the half bridge system has a balanced logic element.

FIG. 4 is a schematic view of another embodiment of a hydraulic circuit in accordance with principles of the present disclosure, the hydraulic circuit including a half bridge system adapted to provide a load sense system and a flow sharing feature where the half bridge system has a pilot-to-open check valve.

FIG. 5 is a schematic view of another embodiment of a hydraulic circuit in accordance with principles of the present disclosure, the hydraulic circuit including a half bridge system adapted to provide a load sense system where the half bridge system has a pilot-operated main directional valve using a pair of proportional pilot valves.

FIG. 6 is a schematic view of another embodiment of a hydraulic circuit in accordance with principles of the present disclosure, the hydraulic circuit including a half bridge system adapted to provide a load sense system where the half bridge system has a pilot-operated main directional valve using a pair of on-off pilot valves.

FIG. 7 is a schematic view of another embodiment of a hydraulic circuit in accordance with principles of the present disclosure, the hydraulic circuit including a half bridge system adapted to provide a pre-compensated load sense system.

It should be understood that the drawings are not necessarily to scale and that the disclosed embodiments are illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of a hydraulic actuator system constructed in accordance with principles of the present disclosure are adapted to control the operation of one or more actuators of a vehicle (e.g., telehandlers, backhoe loaders, wheel loaders, tractors, excavators). Embodiments of a hydraulic actuator system constructed in accordance with principles of the present disclosure can have the same or similar functionality as conventional circuits, but with reduced cost and complexity.

Embodiments of a hydraulic actuator system constructed in accordance with principles of the present disclosure can include a secondary manifold with a secondary valve that is configured to direct a meter-in flow received from a main directional control valve to an actuator and to direct a meter-out flow of fluid received from the actuator directly to a tank without the meter-out flow of fluid travelling back through the main directional control valve. In embodiments, the secondary valve comprises a load-holding valve. In embodiments, the hydraulic actuator system has a separate return flow connection that permits the use of a load-holding valve (such as, e.g., counterbalance valves, motion control valves, pilot-operated check valves, or zero-leakage logic elements) as the secondary valve, which can be flanged on the machine's actuator (such as, e.g., a linear cylinder, a rotary cylinder, or a hydraulic motor), or otherwise associated with the actuator, that is adapted to direct a meter-out flow of hydraulic fluid from the actuator to tank without driving the return flow through the main directional control valve.

Embodiments of a hydraulic actuator system constructed in accordance with principles of the present disclosure can help reduce the overall pressure drop of the system. In addition, embodiments of a hydraulic actuator system constructed in accordance with principles of the present disclosure can operate without the use of complex software requiring fast-processing electronic control units (ECU's) (or additional sensors associated therewith).

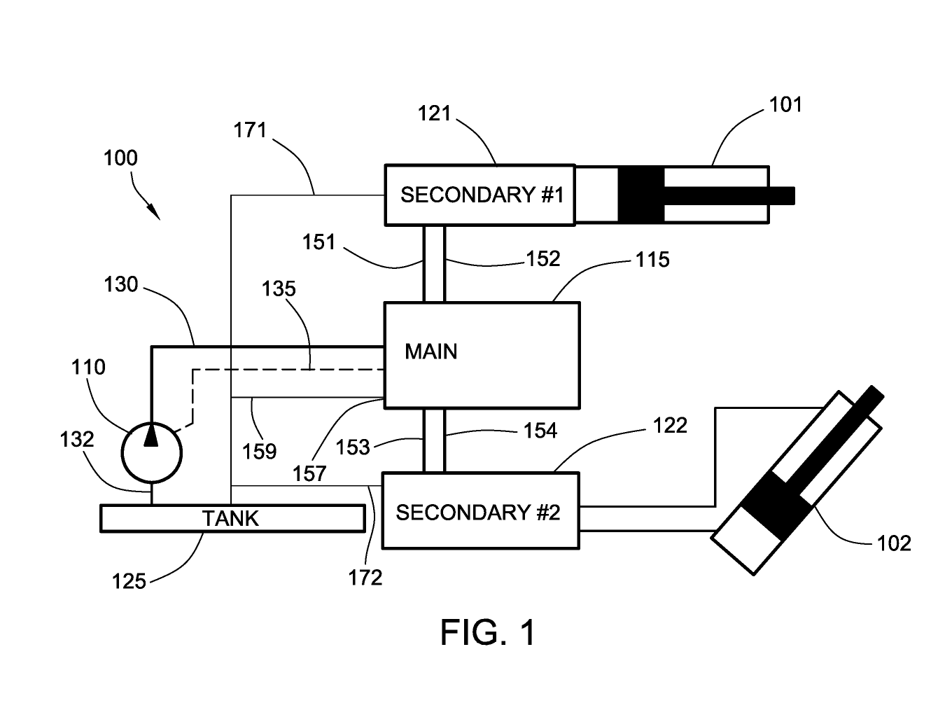

Turning now to the Figures, an embodiment of a hydraulic actuator system 100 constructed according to principles of the present disclosure is shown in FIG. 1. In embodiments, the hydraulic actuator system 100 is adapted to selectively operate a plurality of hydraulic actuators 101, 102. The hydraulic actuator system 100 illustrated in FIG. 1 includes a pump 110; a main manifold housing a main directional control valve 115; a pair of secondary manifolds respectively housing a secondary valve 121, 122; the pair of actuators 101, 102; and a tank 125. Those of skill in the art will appreciate that other embodiments can include three or more such secondary manifolds respectively housing secondary valves coupled respectively to three or more such actuators and a tank.

The pump 110 is in fluid communication with the tank 125 and the main directional control valve 115. The pump 110 is adapted to receive a supply of fluid from the tank 125 and to discharge a meter-in flow of fluid to the main directional control valve 115.

The main directional control valve 115 is in fluid communication with the pump 110, the secondary valves 121, 122 and the tank 125. The main directional control valve 115 is in fluid communication with the pump 110 and the secondary valves 121, 122 such that the main directional control valve 115 is interposed between each of the secondary valves 121, 122 and the pump 110. The main directional control valve 115 is adapted to selectively direct the meter-in flow of fluid from the pump 110 to each of the secondary valves 121, 122.

The secondary valves 121, 122 are respectively in fluid communication with the main directional control valve 115 and the first actuator 101 and the main directional control valve 115 and the second actuator 102 such that the secondary valves 121, 122 are interposed between the main directional control valve 115 and the first and second actuators 101, 102, respectively. The secondary valves 121, 122 are each adapted to direct the meter-in flow of fluid from the main directional control valve 115 to the actuator 101, 102 with which it is associated.

The secondary valves 121, 122 are respectively in fluid communication with the first actuator 101 and the tank 125 and the second actuator 102 and the tank 125 such that the secondary valves 121, 122 are interposed between the tank 125 and the actuators 101, 102, respectively. The secondary valves 121, 122 are each adapted to receive a meter-out flow of fluid from the actuator 101, 102 with which it is associated and to direct the meter-out flow of fluid to the tank 125. The fluid communication of each secondary valve 121, 122 with the tank 125 is configured such that the meter-out flow of fluid from the actuators 101, 102, respectively, is communicated through each secondary valve 121, 122 to the tank 125 without passing through the main directional control valve 115.

The first and second actuators 101, 102 are in respective fluid communication with the pair of secondary valves 121, 122 such that they receive the meter-in flow of hydraulic fluid therefrom and discharge a meter-out flow of hydraulic fluid thereto. The secondary valves 121, 122 are in fluid communication with the tank 125 such that the meter-out return flow of hydraulic fluid respectively received from the first and second actuators 101, 102 is conveyed from the secondary valves 121, 122 directly to the tank 125 without returning back through the main directional control valve 115.

In embodiments, the actuators 101, 102 can be any suitable actuator. Each of the illustrated actuators 101, 102 includes a body and a piston assembly disposed within the body and being reciprocally movable over a range of travel between a retracted position and an extended position. The piston assembly includes a piston and a rod, at least a portion of which extends from the body. The body defines an internal chamber with a first port and a second port in communication therewith. The piston is movably disposed within the chamber of the body to define a variable volume piston-side chamber in communication with the first port and a rod-side chamber in communication with the second port.

In embodiments, the pump 110 can be any suitable pump that is acceptable for the intended application, as will be readily understood by one skilled in the art. For example, in embodiments, the pump 110 can be a fixed-displacement pump or a variable-displacement pump. The pump 110 is in fluid communication with the main directional control valve 115 via a main supply line 130 to selectively deliver a meter-in flow of hydraulic fluid to the main directional control valve 115. In embodiments, the pump 110 can be in fluid communication with the tank 125 via any suitable technique. For example, in embodiments, the pump 110 is in fluid communication with the tank 125 via a pump supply line 132 to receive a supply flow of hydraulic fluid from the tank 125, which in turn can be used by the pump 110 to deliver the meter-in flow of hydraulic fluid to the main directional control valve 115.

The tank 125 is adapted to hold a reservoir of fluid. In embodiments, the tank 125 can be any suitable tank that is acceptable for the intended application, as will be readily understood by one skilled in the art. Further, those of skill in the art will appreciate that in embodiments the tank 125 can comprise a single tank or a plurality of tanks as the case may be.

In embodiments, a load sense line 135 is supplied between the pump 110 and the main direction control valve 115 and can be adapted to selectively change the operating condition of the main directional control valve 115. In embodiments, the load sense line 135 can be arranged with a load sense pump, a system using a gear pump and a bypass compensator, a sensor of an electric load sense arrangement, or any other suitable equipment, as one of ordinary skill in the art would appreciate. In embodiments, electronic load sensing can replace the load sense line 135 (such as, when the system 100 includes a variable displacement pump, for example).

The main directional control valve 115 can be adapted to control the amount of the meter-in flow that is directed to one or both of the actuators 101, 102 via the secondary valves 121, 122, respectively. In embodiments, the main directional control valve 115 can be adapted to independently operate any one of the actuators with which it is associated at any given time. In embodiments, the main directional control valve 115 can be adapted to direct meter-in flows of hydraulic fluid to multiple actuators 101, 102 at the same time. In embodiments, the main directional control valve 115 can be adapted to operate a subset or all of the actuators with which it is associated simultaneously.

In the illustrated embodiment, the main direction control valve 115 is in fluid communication with the first secondary valve 121 via a first pair of secondary valve supply lines 151, 152 and with the second secondary valve 122 via a second pair of secondary valve supply lines 153, 154. In embodiments, the main directional control valve 115 is configured such that it can selectively direct a meter-in flow of hydraulic fluid through one of the first pair of secondary valve supply lines 151, 152 to the secondary valve 121 to selectively fill either side of the first actuator 101, and through one of the second pair of secondary valve supply lines 153, 154 to the secondary valve 122 to selectively fill either side of the second actuator 102.

In embodiments, the main directional control valve 115 housed within the main manifold is configured such that it provides metering in and/or pressure control functionality for the actuators 101, 102, but does not provide a metering out function from them. In embodiments, the main manifold can have a variety of configurations, such as, a pre-compensated or post-compensated main control manifold, a post-compensated version with flow sharing, a manifold with no compensation, or a manifold with ELS/electronic flow sharing, for example.

In the illustrated embodiment, the main manifold includes a tank port 157 which is in fluid communication with the tank 125 via a main tank return line 159. The main tank return line 159 is not used to carry a meter-out flow of fluid from either of the actuators 101, 102, but rather can be used to provide a return feature when using a fixed displacement pump and/or when the main directional control valve 115 is pilot-operated via an external hydraulic fluid source. In embodiments, the tank port 157 can be omitted (such as when the pump 110 comprises a variable displacement pump).

The first secondary manifold includes the first secondary valve 121 and can include a plurality of ports to fluidly connect the first secondary valve 121 to the main directional control valve 115, the first actuator 101, and the tank 125. A first secondary tank return line 171 can be provided to fluidly connect the first secondary valve 121 and the tank 125 such that a meter-out flow of fluid from the first actuator 101 can be directed through the first secondary valve 121 to the tank 125 via the first secondary tank return line 171 (and without passing through the main directional control valve 115). The second secondary valve 122 can have a similar arrangement such that a second secondary tank return line 172 fluidly connects the second secondary valve 122 and the tank 125 such that a meter-out flow of fluid from the second actuator 102 can be directed through the second secondary valve 122 to the tank 125 via the second secondary tank return line 172 (and without passing through the main directional control valve 115). Accordingly, return flow from the actuators 101, 102 does not pass through the main manifold 115 in the illustrated embodiment of FIG. 1. The first and second secondary tank return lines 171, 172 each directly connect the tank 125 to the first and second secondary valves 121, 122, respectively.

In the illustrated embodiment, each of the secondary valves 121, 122 is adapted to direct the meter-in flow of hydraulic fluid from the main directional control valve 115 to one of the sides of the respective actuators 101, 102 and to direct a meter-out return flow of hydraulic fluid from the other side of the actuators 101, 102 to the tank 125 via the secondary tank return lines 171, 172, respectively. In embodiments, the secondary valves 121, 122 can comprise any suitable valve or assembly of valves, as will be appreciated by one skilled in the art.

In embodiments, each of the secondary valves 121, 122 can be configured to act as a load-holding valve. In embodiments, each of the secondary load-holding valves 121, 122 can have a variety of configurations as will be appreciated by one skilled in the art, such as, e.g., a counterbalance valve, a motion control valve, a pilot-operated check valve, or a zero-leakage logic element. In embodiments, it will be similarly appreciated that the secondary valves 121, 122 can have a variety of mounting configurations with respect to the actuator with which they are respectively associated (such as, being flanged, integrated or installed in another suitable manner to the hydraulic actuator, for example). In the illustrated embodiment, the first secondary valve 121 is connected to the first 101 actuator via a flanged arrangement. In other embodiments, other suitable types of connection can be used, such as a hose, a “banjo” fitting, or a tube, for example.

In embodiments, each of the secondary manifolds 121, 122 can be adapted to provide protection from the pressure exceeding a predetermined maximum value for the respective actuator 101, 102 with which they are associated. In embodiments, for example, the secondary manifolds 121, 122 can include a component or feature to be used for pressure-relief protection of the actuators 101, 102. For example, in embodiments, a pressure-relief feature can be integrated in the secondary valves 121, 122 themselves (e.g. in a counterbalance valve for load holding). In other embodiments, the secondary valves 121, 122 can include a plurality of valves such that an additional relief valve can be housed in one or both of the secondary manifolds including load-holding secondary valves 121, 122. In embodiments, such functionality can be adapted to work for full application flow or as a pilot relief to open the load-holding element. In yet other embodiments, the additional tank lines 171, 172 from the load holding manifolds 121, 122 can be configured to protect additional components, which can be connected to the associated actuator 101, 102, like an accumulator which is used in a boom suspension system, for example (not illustrated in FIG. 1).

In embodiments, the hydraulic actuator system 100 can be used with any suitable type of actuator. For example, in embodiments, the hydraulic actuators 101, 102 can comprise a cylinder, a rotary cylinder, a hydraulic motor, or other suitable actuator.

In embodiments, the tank 125 can be any suitable tank known to those skilled in the art. In embodiments, the tank 125 comprises a reservoir of hydraulic fluid which can be drawn into the pump 110 in order to generate a meter-in flow of hydraulic fluid for the system 100.

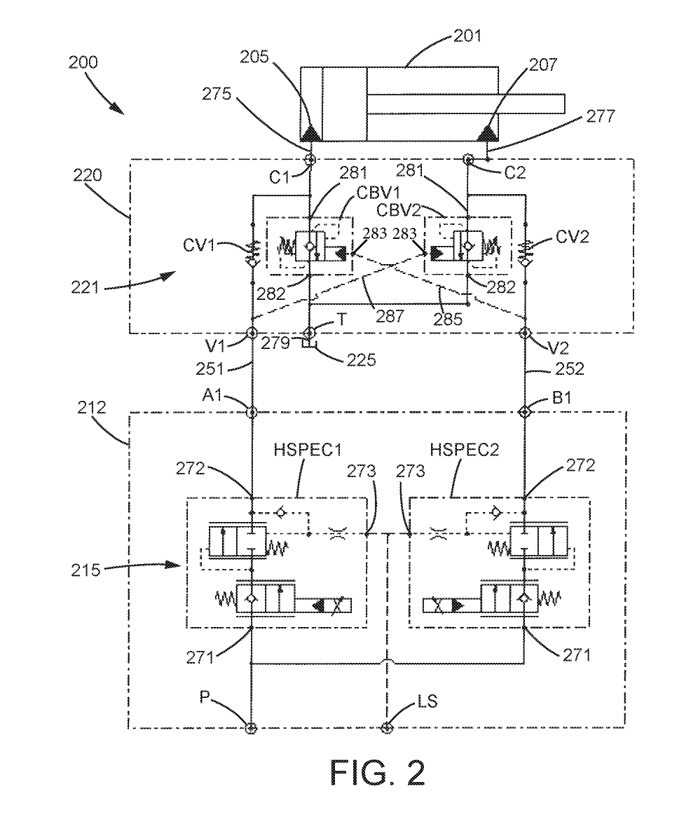

Referring to FIG. 2, another embodiment of a hydraulic actuator system 200 constructed according to principles of the present disclosure is shown. In embodiments, the hydraulic actuator system 200 is adapted to selectively operate a hydraulic actuator 201. The illustrated hydraulic actuator system 200 includes a main manifold 212 housing a main directional control valve 215, a secondary manifold 220 housing a secondary valve 221, and a tank 225. The secondary valve 221 is in fluid communication with the tank 225 such that a meter-out return flow of hydraulic fluid received from the actuator 201 is conveyed from the secondary valve 221 directly to the tank 225 without returning back through the main directional control valve 215. The illustrated hydraulic actuator system 200 is adapted to provide flow control meter-in functionality via the main directional control valve 215 coupled with pressure control meter-out functionality provided by the secondary valve 221.

The main directional control valve 215 can be placed in fluid communication with a suitable pump, such as is shown in FIG. 1. The main directional control valve 215 is in fluid communication with the secondary valve 221. The secondary valve 221 is in fluid communication with the main directional control valve 215 and the hydraulic actuator 201. The secondary valve 221 is interposed between the main directional control valve 215 and the hydraulic actuator 201 such that the secondary valve 221 can selectively direct a meter-in flow of hydraulic fluid received from the main directional control valve 215 into one of the sides 205, 207 of the hydraulic actuator 201. The secondary valve 221 is also in fluid communication with the tank 225 such that a meter-out return flow of hydraulic fluid received from the other of the sides 205, 207 of the hydraulic actuator 201 is conveyed from through the secondary valve 221 directly to the tank 225 without returning back through the main directional control valve 215. The hydraulic actuator 201 is in fluid communication with the secondary valve 221 such that it receives a meter-in flow of hydraulic fluid therefrom and discharges a meter-out flow of hydraulic fluid thereto.

In the illustrated embodiment, the main manifold 212 includes a pump port P, a load sense port LS, a first outlet port A1, and a second outlet port B1. A main supply line can be connected to the pump port P to fluidly connect the main manifold 212 to a pump, such as is shown in FIG. 1. A load sense port LS can be fluidly connected to a load sense line (such as the load sense line 135 shown in FIG. 1) which can be arranged with a load sense pump, a system using a gear pump and a bypass compensator, or any other suitable equipment, as one of ordinary skill in the art would appreciate, whereby a load sense flow of hydraulic fluid is directed to the main directional control valve through pump port P to achieve the desired valve operation. The first and second outlet ports A1, B1 are in fluid communication with the secondary valve 221 housed within the secondary manifold 220 via a pair of secondary supply lines 251, 252, respectively. In embodiments, the main manifold 212 can be remotely situated relative to the position of the secondary manifold 220 yet still fluidly connected together via the secondary supply lines 251, 252.

In the illustrated embodiment, the main directional control valve 215 is adapted to provide a flow control meter-in feature. Flow sharing can be helpful in applications where a machine operates multiple actuators simultaneously. Accordingly, one skilled in the art will understand that, although the hydraulic actuator system 200 of FIG. 2 is shown with a single actuator 201, in embodiments, the main directional control valve 215 can be scaled to control a plurality of actuators simultaneously (not illustrated in FIG. 2), each actuator having a secondary valve arranged with it which is directly connected to tank. In embodiments, the flow-sharing feature can help allocate the hydraulic flow appropriately to all functions to which the main directional control valve 215 provides meter-in flow. In embodiments, the main directional control valve 215 can be adapted to provide a flow control meter-in feature using any suitable technique known to those skilled in the art.

For example, in the illustrated embodiment, the main directional control valve 215 includes a first flow control valve HSPEC1 and a second flow control valve HSPEC2 which are both in fluid communication with the pump port P and the load sense port LS of the main manifold 212. In embodiments, the first and second flow control valves HSPEC1, 2 can be any suitable flow control valve adapted to provide flow sharing. For example, in the illustrated embodiment, the first and second flow control valves HSPEC1, 2 comprise commercially-available flow control valves from HydraForce, Inc. of Lincolnshire, Ill., marketed under the model number HSPEC.

In the illustrated embodiment, the first and second flow control valves HSPEC1, 2 are substantially the same and are similarly configured. The first and second flow control valves HSPEC1, 2 are both proportional, three-way, normally-closed, solenoid-operated cartridge valves that are adapted for post-compensated applications with a load-sense system. Each flow control valve HSPEC1, 2 includes a flow valve inlet port 271, a flow valve outlet port 272, and a flow valve load sense port 273. The flow valve inlet ports 271 of both the first and second flow control valves HSPEC1, 2 are in fluid communication with the pump port P of the main manifold 212. The flow valve outlet port 272 of the first and second flow control valves HSPEC1, 2 are in respective fluid communication with the first and second outlet ports A1, B1 of the main manifold 212. The flow valve load sense ports 273 of the first and second flow control valves HSPEC1, 2 are both in fluid communication with the load sense port LS of the main manifold 212.

When the solenoid of the flow control valve HSPEC1, 2 is de-energized, the flow control valve HSPEC1, 2 is in a blocking position in which fluid flow from the flow valve inlet port 271 to the flow valve outlet port 272 is blocked. When the solenoid of the flow control valve HSPEC1, 2 is energized, the flow control valve HSPEC1, 2 is in a flow position in which fluid flow from the flow valve inlet port 271 to the flow valve outlet port 272 is permitted with the flow rate proportional to the current applied to the solenoid. Each of the flow control valves HSPEC1, 2 includes a built in post-compensator. Each flow control valve HSPEC1, 2 is adapted to regulate flow out of the flow valve outlet port 272 regardless of load pressure, with the flow rate proportional to the current applied to the solenoid. As used in the post-compensated hydraulic actuator system 200 of FIG. 2, the flow valve load sense port 273 of each of the flow control valves HSPEC1, 2 is connected to the highest load to maintain flow sharing when flow demand exceeds flow supply. In some embodiments, each of the flow control valves HSPEC1, 2 valve can be fine-tuned independently, thereby making it possible to help refine the meter-in performance of each flow control valve HSPEC1, 2 to the particular functionality of the hydraulic actuator 201.

In the illustrated embodiment, the secondary manifold 220 includes a first inlet port V1, a second inlet port V2, a first work port C1, a second work port C2, and a tank port T. The first and second secondary supply lines 251, 252 are connected respectively to the first and second outlet ports A1, B1 of the main manifold 212 and connected respectively to the first and second inlet ports V1, V2 of the secondary manifold 220. Accordingly, the first inlet port V1 of the secondary manifold 220 is in fluid communication with the first outlet port A1 of the main manifold 212, and the second inlet port V2 of the secondary manifold 212 is in fluid communication with the second outlet port B1 of the main manifold 212. The first work port C1 of the secondary manifold 220 is in fluid communication with the first side 205 of the actuator 201 via a first-side line 275. The second work port C2 of the secondary manifold 220 is in fluid communication with the second side 207 of the actuator 201 via a second-side line 277. The tank port T of the secondary manifold 220 is in fluid communication with the tank 225 via a secondary tank return line 279. The tank 225, in turn, can be in fluid communication with the pump that supplies the meter-in flow of hydraulic fluid to the pump port P of the main manifold 212, as one skilled in the art would appreciate.

In embodiments, the secondary manifold 220 can be mounted in close proximity to the actuator 201 with which it is associated. In other embodiments, the secondary manifold 220 can have multiple load-holding valves that are fluidly connected to different actuators and can be remotely positioned relative to one or more actuators with which it is associated.

In the illustrated embodiment, the secondary valve 221 is adapted to provide a pressure control meter-out feature. The secondary valve 221 can be adapted to work with an overriding (running-away) or suspended load and can be adapted to create backpressure at the return side of the actuator 201 to prevent losing control of the load. In embodiments, the secondary valve 221 is adapted to provide a pressure control meter-out feature using any suitable technique known to those skilled in the art.

For example, in the illustrated embodiment, the secondary valve 221 includes a first check valve CV1, a second check valve CV2, a first counterbalance valve CBV1, and a second counterbalance valve CBV2. The first check valve CV1 and the first counterbalance valve CB are arranged with the first inlet port V1, the second inlet port V2, the first work port C1, and the tank port T, and in a similar manner the second check valve CV2 and the second counterbalance valve CBV2 are arranged with the second inlet port V2, the first inlet port V1, the second work port C2, and the tank port T. Accordingly, the description of one check valve CV1, 2 or of one counterbalance valve CBV1, 2 is applicable to the other, as well, but in a mirror image manner.

The first check valve CV1 is interposed between the first inlet port V1 and the first work port C1 such that a meter-in flow of hydraulic fluid is permitted to travel from the first inlet port V1 to the first work port C1 through the first check valve CV1. The first check valve CV1 is arranged such that the first check valve CV1 blocks a meter-out flow of hydraulic fluid from the first work port C1 from flowing to the first inlet port V1. The first counterbalance valve is interposed between the first work port C1 and the tank port T and is adapted to selectively block a meter-out flow of hydraulic fluid from flowing from the first work port C1 through the first counterbalance valve CBV1 to the tank port T, but permits the reverse flow.

The second check valve CV2 is interposed between the second inlet port V2 and the second work port C2 such that a meter-in flow of hydraulic fluid is permitted to travel from the second inlet port V2 to the second work port C2 through the second check valve CV2. The second check valve CV2 is arranged such that the second check valve CV2 blocks a meter-out flow of hydraulic fluid from the second work port C2 from flowing to the second inlet port V2. The second counterbalance valve CBV2 is interposed between the second work port C2 and the tank port T and is adapted to selectively block a meter-out flow of hydraulic fluid from flowing from the second work port C2 through the second counterbalance valve CBV2 to the tank port T, but permits the reverse flow.

In embodiments, each of the first and second counterbalance valves CBV1, 2 can be adapted to control actuator motion by maintaining a positive load pressure through the secondary valve 221, even with an overrunning load. In embodiments, the first and second counterbalance valves CBV1, 2 can be any suitable counterbalance valves.

For example, in the illustrated embodiment, the first and second counterbalance valves CBV1, 2 comprise pilot-assisted counterbalance valves which are substantially the same and are similarly configured. Each counterbalance valve CBV1, 2 includes a load port 281, a counterbalance valve outlet port 282, and a pilot port 283. The load ports 281 of the first and second counterbalance valves CBV1, 2 are in respective fluid communication with the first and second work ports C1, C2 of the secondary manifold 220. The counterbalance valve outlet ports 282 of the first and second counterbalance valves CBV1, 2 are both in fluid communication with the tank port T of the secondary manifold 220. The pilot ports 283 of the first and second counterbalance valves CBV1, 2 are in respective fluid communication with the second inlet port V2 and the first inlet port V1 of the secondary manifold 220 via first and second pilot lines 285, 287.

The first counterbalance valve CBV1 is fluidly connected to the second inlet port V2 via the first pilot line 285 to receive a pilot flow of hydraulic fluid therefrom. The second counterbalance valve CBV2 is fluidly connected to the first inlet port V1 via the second pilot line 287 to receive a pilot flow of hydraulic fluid therefrom.

The first and second counterbalance valves CBV1, 2 comprise pilot-to-open assist valves that are adapted to be modulating to permit the flow of hydraulic fluid from the counterbalance valve outlet port 282 to the load port 281 and block a meter-out flow of fluid from the load port 281 to the counterbalance valve outlet port 282 until a pilot pressure inversely proportional to the load pressure is applied at pilot port 283. The modulation of a counterbalance valve is a function of both the load pressure and the pilot pressure such that smaller loads require greater pilot pressure and larger loads less pilot pressure to open the counterbalance valves CBV1, 2, thereby helping to improve stability and providing motion control. In the event that an overload condition occurs, the affected counterbalance valve CBV1, 2 will close to block the meter-out flow of hydraulic fluid from the load port 281 to the counterbalance valve outlet port 282 until the overload condition resolves, at which point the meter-out flow of fluid can be permitted to flow to the tank 225.

In embodiments, the main directional control valve 215 is adapted to be movable between a first-side fill position, a second-side fill position, and a neutral (or load hold) position. In the first-side fill position, the first side 205 of the actuator 201 is in fluid communication with the pump port P of the main manifold 212 (via the energized first flow control valve HSPEC1 and the first check valve CV1) to receive a meter-in flow of hydraulic fluid therein to fill the first side 205 of the actuator 201 with hydraulic fluid, and the second side 207 of the actuator 201 is selectively in fluid communication with the tank 225 (via the second counterbalance valve CBV2 as a function of the pilot pressure received from the second pilot line 287) to drain a meter-out flow of hydraulic fluid from the second side 207 of the actuator 201 directly to the tank 225 without passing through the main directional control valve 215.

In the second-side fill position, the second side 205 of the actuator 201 is in fluid communication with the pump port P of the main manifold 212 (via the energized second flow control valve HSPEC2 and the second check valve CV2) to receive a meter-in flow of hydraulic fluid therein to fill the second side 207 of the actuator 201 with hydraulic fluid, and the first side 205 of the actuator 201 is selectively in fluid communication with the tank 225 (via the first counterbalance valve CBV1 as a function of the pilot pressure received from the first pilot line 285) to drain a meter-out flow of hydraulic fluid from the first side 205 of the actuator 201 directly to the tank 225 without passing through the main directional control valve 215.

In the neutral position 122, both of the first and second flow control valves HSPEC1, 2 are de-energized, and the actuator 201 is fluidly isolated from each of the pump port P of the main manifold 212 and the tank 225 such that the position of the actuator 201 is maintained, or held in place. In the illustrated embodiment, the main directional control valve 215 is biased to the neutral position. Other details concerning the structural features and operation of the hydraulic actuator system 200 of FIG. 2 will be apparent to one skilled in the art upon review of FIG. 2.

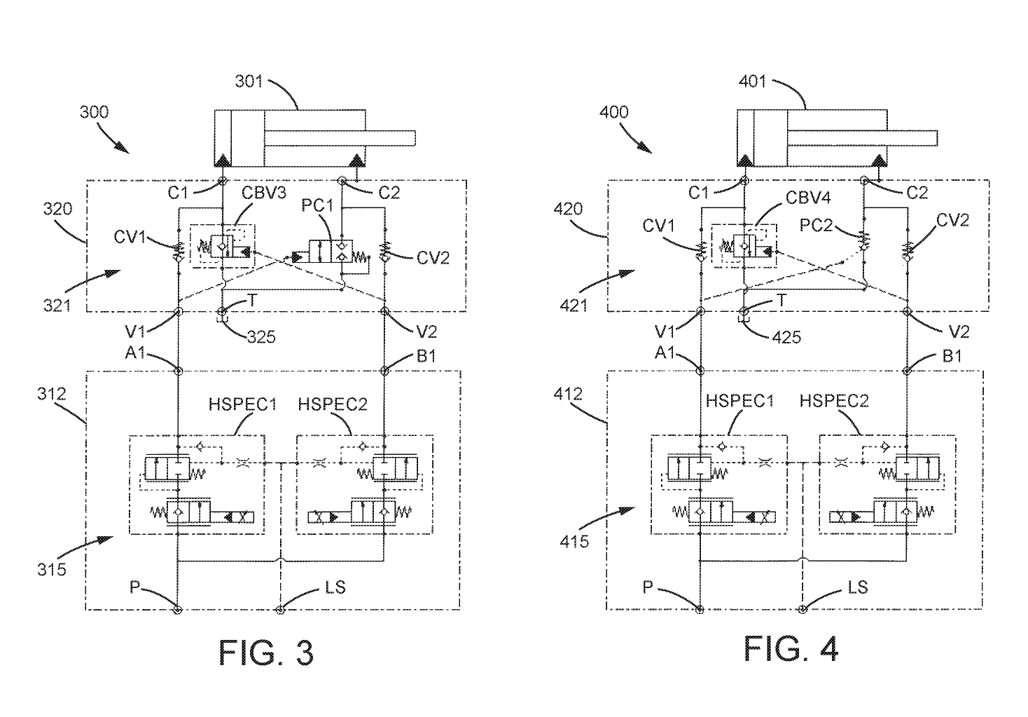

Referring to FIG. 3, another embodiment of a hydraulic actuator system 300 constructed according to principles of the present disclosure is shown. In embodiments, the hydraulic actuator system 300 is adapted to selectively operate a hydraulic actuator 301. The illustrated hydraulic actuator system 300 includes a main manifold 312 housing a main directional control valve 315 and a secondary manifold 320 housing a secondary valve 321, and a tank 325. The secondary valve 321 is in fluid communication with the tank 325 via tank port T such that a meter-out return flow of hydraulic fluid received from the actuator 301 is conveyed from the secondary valve 321 directly to the tank 325 without returning back through the main directional control valve 315. The illustrated hydraulic actuator system 300 is adapted to provide flow control meter-in functionality via the main directional control valve 315 coupled with load-holding functionality provided by the secondary valve 321.

The main manifold 312, the main directional control valve 315, and the secondary manifold 320 of FIG. 3 are substantially the same as the main manifold 212, the main directional control valve 215, and the secondary manifold 220, respectively, of FIG. 2. The secondary valve 321 of FIG. 3 is substantially the same as the secondary valve 221 of FIG. 2 except that the second counterbalance valve CBV2 has been replaced by a pilot-operated, balanced logic element PC1 in which back pressure in the system 300 does not affect meter-out operation. The hydraulic actuator system 300 of FIG. 3 can be used as a lower-cost option to the hydraulic actuator system 200 of FIG. 2 in certain applications. The hydraulic actuator system 300 of FIG. 3 can be functionally similar in other respects to the hydraulic actuator system 200 of FIG. 2. Other details concerning the structural features and operation of the hydraulic actuator system 300 of FIG. 3 will be apparent to one skilled in the art upon review of FIG. 3.

Referring to FIG. 4, another embodiment of a hydraulic actuator system 400 constructed according to principles of the present disclosure is shown. In embodiments, the hydraulic actuator system 400 is adapted to selectively operate a hydraulic actuator 401. The illustrated hydraulic actuator system 400 includes a main manifold 412 housing a main directional control valve 415 and a secondary manifold 420 housing a secondary valve 421, and a tank 425. The secondary valve 421 is in fluid communication with the tank 425 such that a meter-out return flow of hydraulic fluid received from the actuator 401 is conveyed from the secondary valve 421 directly to the tank 425 without returning back through the main directional control valve 415. The illustrated hydraulic actuator system 400 is adapted to provide flow control meter-in functionality via the main directional control valve 415 coupled with load-holding functionality provided by the secondary valve 421.

The main manifold 412, the main directional control valve 415, and the secondary manifold 420 of FIG. 4 are substantially the same as the main manifold 212, the main directional control valve 215, and the secondary manifold 220, respectively, of FIG. 2. The secondary valve 421 of FIG. 4 is substantially the same as the secondary valve 221 of FIG. 2 except that the second counterbalance valve CBV2 has been replaced by a pilot-to-open check valve PC2 in which back pressure in the system 400 can affect meter-out operation. The hydraulic actuator system 400 of FIG. 4 can be used as a lower-cost option to the hydraulic actuator system 200 of FIG. 2 in certain applications. The hydraulic actuator system 400 of FIG. 4 can be functionally similar in other respects to the hydraulic actuator system 200 of FIG. 2. Other details concerning the structural features and operation of the hydraulic actuator system 400 of FIG. 4 will be apparent to one skilled in the art upon review of FIG. 4.

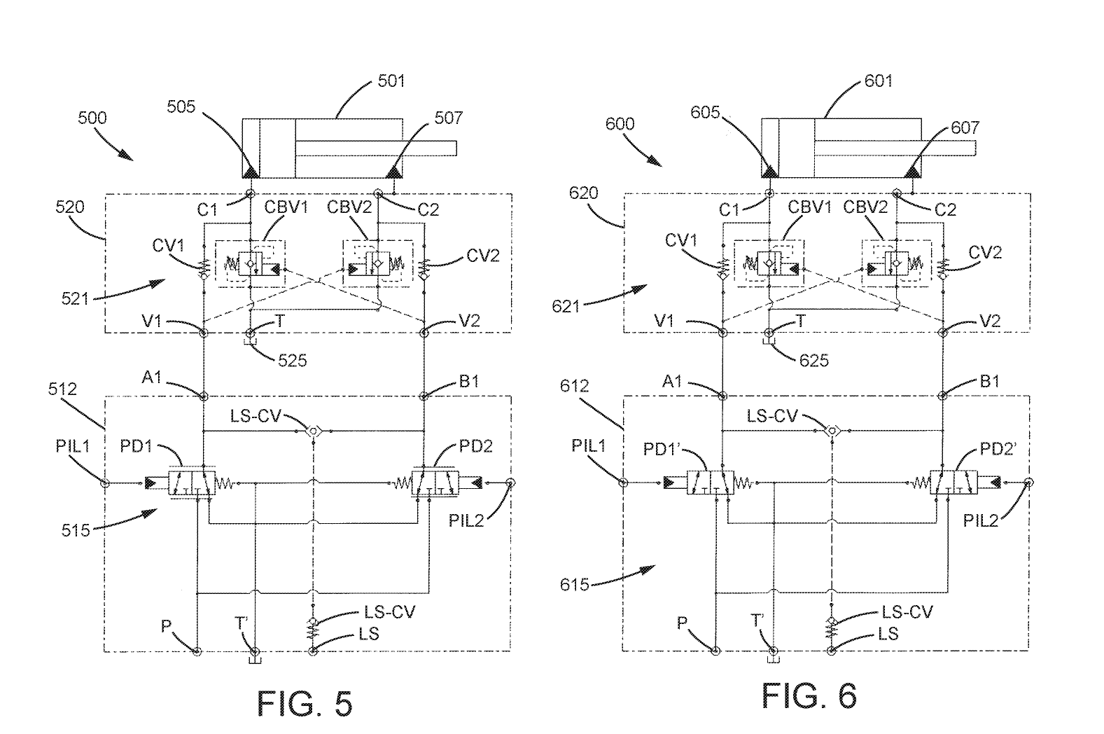

Referring to FIG. 5, another embodiment of a hydraulic actuator system 500 constructed according to principles of the present disclosure is shown. In embodiments, the hydraulic actuator system 500 can be used to selectively operate a hydraulic actuator 501. The illustrated hydraulic actuator system 500 includes a main manifold 512 housing a main directional control valve 515 and a secondary manifold 520 housing a secondary valve 521, and a tank 525. The secondary valve 521 is in fluid communication with the tank 525 such that a meter-out return flow of hydraulic fluid received from the actuator 501 is conveyed from the secondary valve 521 directly to the tank 525 without returning back through the main directional control valve 515. The illustrated hydraulic actuator system 500 is adapted to provide pilot-operated meter-in functionality via the main directional control valve 515 coupled with pressure control meter-out functionality provided by the secondary valve 521.

The secondary manifold 520 and the secondary valve 521 of FIG. 5 are substantially the same as the secondary manifold 220 and the secondary valve 221, respectively, of FIG. 2. The main manifold 512 of FIG. 5 is substantially the same as the main manifold 212 of FIG. 2 except that main manifold 512 of FIG. 5 includes additional ports, namely first and second pilot ports PILL 2 and a main tank port T′. The main directional control valve 515 of FIG. 5 can include first and second proportional pilot valves PD1, PD2. The main directional control valve 515 is adapted to be movable between a first-side fill position, a second-side fill position, and a neutral (or load hold) position. The main directional control valve 515 is biased to the neutral position.

The first and second pilot ports PILL 2 are in fluid communication with the first and second proportional pilot valves PD1, 2, respectively. An external pilot flow of hydraulic fluid can be independently delivered to the proportional pilot valves PD1, PD2 to control a meter-in flow of hydraulic fluid from the pump port P of the main manifold to one of the sides 505, 507 of the actuator 501 to place the main directional control valve 515 in one of the first-side fill position or the second-side fill position, respectively. The flow rate of the meter-in flow of hydraulic fluid can be proportional to the pressure of the pilot flow of hydraulic fluid applied to the particular proportional pilot valve PD1, PD2 being operated.

Both the first and second proportional pilot valves PD1, PD2 are in fluid communication with the main tank port T′. In embodiments, the pilot flow of hydraulic fluid sent to either of the pair of proportional pilot valves PD1, PD2 can be drained from the valves PD1, PD2 to the main tank port T′. The drain flow of hydraulic fluid can be returned to a suitable tank for use by the external pilot fluid source.

The hydraulic actuator system 500 of FIG. 5 can be functionally similar in other respects to the hydraulic actuator system 200 of FIG. 2. Other details concerning the structural features and operation of the hydraulic actuator system 500 of FIG. 5 will be apparent to one skilled in the art upon review of FIG. 4.

Referring to FIG. 6, another embodiment of a hydraulic actuator system 600 constructed according to principles of the present disclosure is shown. The system 600 of FIG. 6 is substantially the same as the system 500 of FIG. 5 except that the system 600 of FIG. 6 includes a main directional control valve 615 having first and second pilot valves PD1′, PD2′ which comprise on-off type valves rather than proportional valves.

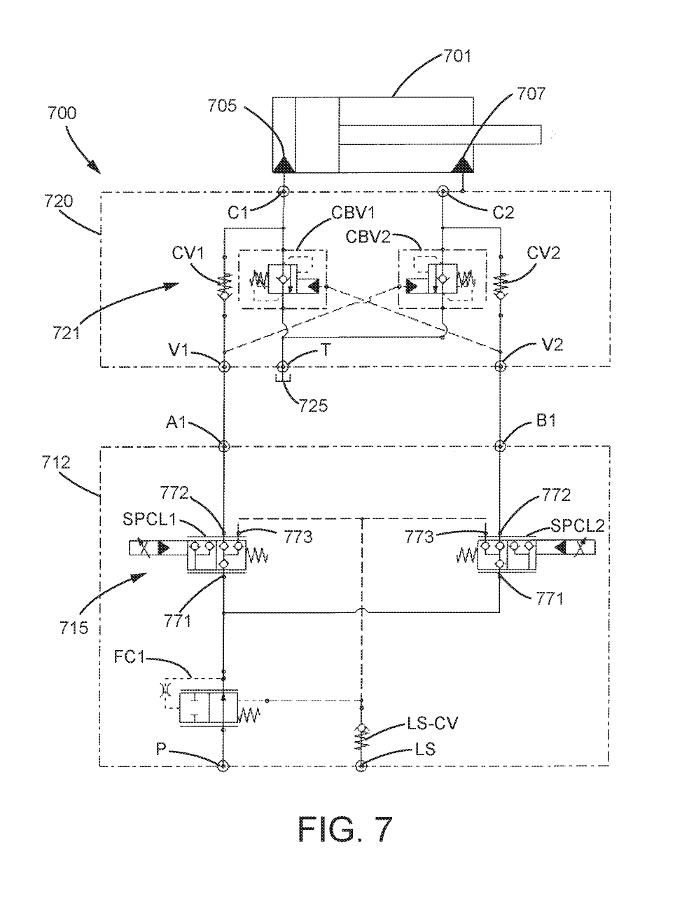

Referring to FIG. 7, another embodiment of a hydraulic actuator system 700 constructed according to principles of the present disclosure is shown. In embodiments, the hydraulic actuator system 700 can be used to selectively operate a hydraulic actuator 701. The illustrated hydraulic actuator system 700 includes a main manifold 712 housing a main directional control valve 715 and a secondary manifold 720 housing a secondary valve 721, and a tank 725. The secondary valve 721 is in fluid communication with the tank 725 such that a meter-out return flow of hydraulic fluid received from the actuator 701 is conveyed from the secondary valve 721 directly to the tank 725 without returning back through the main directional control valve 715. The illustrated hydraulic actuator system 700 is adapted to provide a pre-compensated load sense system via the main directional control valve 715 coupled with pressure control meter-out functionality provided by the secondary valve 721.

The main manifold 712, the secondary manifold 720 and the secondary valve 721 of FIG. 7 are substantially the same as main manifold 212, the secondary manifold 220 and the secondary valve 221, respectively, of FIG. 2. The main directional control valve 715 of FIG. 7 is adapted to act as a pre-compensated load sense system in which the main directional control valve selectively provides a meter-in flow to one of the sides 705, 707 of the actuator 701 which is substantially the same regardless of the pressure of the meter-in flow of hydraulic fluid.

In embodiments, any suitable valve arrangement can be used to provide the pre-compensated configuration. For example, in embodiments, the main directional control valve can include first and second control valves SPCL1, 2 which are both in fluid communication with the pump port P and the load sense port LS of the main manifold 712. In embodiments, the first and second control valves SPCL1, 2 can be any suitable control valves that are adapted to provide the pre-compensated configuration. For example, in the illustrated embodiment, the first and second control valves SPCL1, 2 comprise commercially-available electro-proportional valves from HydraForce, Inc. of Lincolnshire, Ill., marketed under the model number SPCL.

In the illustrated embodiment, the first and second control valves SPCL1, 2 are substantially the same and are similarly configured. The first and second control valves SPCL1, 2 both comprise a solenoid-operated, normally-closed proportional, poppet-type cartridge valve.

Each control valve SPCL1, 2 includes a control valve inlet port 771, a control valve outlet port 772, and a control valve pilot/load sense port 773. The control valve inlet ports 771 of the first and second control valves SPCL1, 2 are in fluid communication with the pump port P of the main manifold 712. The control valve outlet ports 772 of the first and second flow control valves SPCL1, 2 are in respective fluid communication with the first and second outlet ports A1, B1 of the main manifold 712. The control valve pilot/load sense ports 773 of the first and second control valves SPCL1, 2 are both in fluid communication with the load sense port LS of the main manifold 712.

When the coil is de-energized, the control valve SPCL1, 2 blocks flow at all of its ports 771, 772, 773. When the coil is energized, a proportionally-regulated meter-in flow of hydraulic fluid is permitted to flow from the control valve inlet port 771 to the control valve outlet port 772 with a check-isolated load-sense signal supplied at the control valve pilot/load sense port 773 which can be directed to the load sense port LS of the main manifold 712. A meter-out return flow is not allowed to flow from the control valve outlet port 772 to the control valve inlet port 771.

The hydraulic actuator system 700 of FIG. 7 can be functionally similar in other respects to the hydraulic actuator system 200 of FIG. 2. Other details concerning the structural features and operation of the hydraulic actuator system 700 of FIG. 7 will be apparent to one skilled in the art upon review of FIG. 4.

In embodiments, a hydraulic actuator system constructed according to principles of the present disclosure can provide a relatively low leakage solution. In embodiments, a hydraulic actuator system constructed according to principles of the present disclosure can help reduce pressure loss by sending the return flow directly to the tank without passing through the main directional control valve. In comparison, the pressure drop from the actuator to the tank in a traditional spool system or counterbalance system can be relatively higher depending on operation mode.

In embodiments, a hydraulic actuator system constructed according to principles of the present disclosure can be asymmetric and include a downsized nominal flow rate size for the main directional control valve relative to a conventional solution. In embodiments, a hydraulic actuator system constructed according to principles of the present disclosure can include meter-in components sized according to an intended inlet flow demand and meter-out components sized according to an intended outlet flow demand, where the outlet flow demand can be different from the inlet flow demand. In embodiments, multiple sections can be sized to accommodate relatively large variations in nominal flow rate.

In embodiments, a hydraulic actuator system constructed according to principles of the present disclosure can be used with a relatively smaller manifold size and help achieve a lower weight system. In embodiments, a hydraulic actuator system constructed according to principles of the present disclosure can have a reduced overall system cost relative to prior systems such as a four-coil bridge circuit. In embodiments, a hydraulic actuator system constructed according to principles of the present disclosure can be applied to a multi-function machine where several actuators are simultaneously controlled.

In embodiments, a hydraulic actuator system constructed according to principles of the present disclosure which is arranged with a double-acting actuator can include a main directional control valve which can be adapted to provide pressure control for one chamber of the actuator and flow control for the other chamber of the actuator. In embodiments, a hydraulic actuator system constructed according to principles of the present disclosure can include suitable components (as will be appreciated by one skilled in the art) to include additional features, such as, for example, hydro-pneumatic suspension, floating, gravity lowering, redundant components for safety, zero leakage.

Embodiments of a hydraulic actuator system constructed according to principles of the present disclosure can be used to carry out a method of controlling a hydraulic actuator using a secondary manifold with a secondary valve that is configured to direct a meter-in flow received from a main directional control valve to an actuator and to direct a meter-out flow of fluid received from the actuator directly to a tank without the meter-out flow of fluid travelling back through the main directional control valve. In embodiments, the secondary valve comprises a load-holding valve.

In embodiments, a method of controlling a hydraulic actuator following principles of the present disclosure can be used with any embodiment of a hydraulic actuator system according to principles discussed herein. In one embodiment, a method of controlling a hydraulic actuator includes conveying a meter-in flow of fluid from a supply of fluid in a tank to a main directional control valve. The meter-in flow of fluid is selectively directed from the main directional control valve to a secondary valve. The meter-in flow of fluid is directed from the secondary valve to the hydraulic actuator. A meter-out flow of fluid is directed from the hydraulic actuator to the secondary valve. The meter-out flow of fluid is directed from the secondary valve to the tank via a return flow path without passing through the main directional control valve. In embodiments, the return flow path is defined by a secondary tank line that directly fluidly connects the secondary valve to the tank.

In embodiments, the method further includes selectively directing a second meter-in flow of fluid from the main directional control valve to a second secondary valve. The second meter-in flow of fluid is directed from the second secondary valve to a second hydraulic actuator. A second meter-out flow of fluid is directed from the second hydraulic actuator to the second secondary valve. The second meter-out flow of fluid is directed from the second secondary valve to the tank without directing the second meter-out flow of fluid through the main directional control valve.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hydraulic actuator system comprising:
a tank, the tank adapted to hold a reservoir of fluid;
a pump, the pump in fluid communication with the tank, the pump adapted to receive a supply of fluid from the tank and to discharge a meter-in flow of fluid;
a main directional control valve, a secondary valve, and an actuator, the main directional control valve in fluid communication with the pump and the secondary valve such that the main directional control valve is interposed therebetween, the main directional control valve being adapted to selectively direct the meter-in flow of fluid from the pump to the secondary valve;
the secondary valve in fluid communication with the main directional control valve and the actuator such that the secondary valve is interposed between the main directional control valve and the actuator, the secondary valve being adapted to direct the meter-in flow of fluid from the main directional control valve to the actuator;
the secondary valve in fluid communication with the actuator and the tank such that the secondary valve is interposed between the actuator and the tank, the secondary valve being adapted to receive a meter-out flow of fluid from the actuator and to direct the meter-out flow of fluid to the tank, the fluid communication of the secondary valve with the tank being configured such that the meter-out flow of fluid from the actuator is communicated through the secondary valve to the tank without passing through the main directional control valve.

2. The hydraulic actuator system of claim 1, further comprising:
a secondary tank return line, the secondary tank return line fluidly coupling the secondary valve to the tank to provide fluid communication between the actuator and the secondary valve for the meter-out flow of fluid, the secondary tank return line directly connecting the secondary valve to the tank.

3. The hydraulic actuator system of claim 1, wherein the secondary valve is connected to the actuator via a flanged arrangement.

4. The hydraulic actuator system of claim 1 wherein the secondary valve comprises a load-holding device.

5. The hydraulic actuator system of claim 4, wherein the load-holding valve device comprises a double-blocking solenoid valve.

6. The hydraulic actuator system of claim 4, wherein the load-holding device comprises a check valve and a counterbalance valve.

7. The hydraulic actuator system of claim 6, wherein the actuator defines a first port, a second port, and a chamber therein, the first and second ports in communication with the chamber, the chamber adapted to receive fluid therein, wherein the check valve of the secondary valve is in fluid communication with the first port of the actuator and the main directional control valve such that the check valve is interposed therebetween, the check valve being adapted to direct the meter-in flow from the main directional control valve to the first port of the actuator, and wherein the counterbalance valve is in fluid communication with the second port of the actuator and the tank such that the counterbalance valve is interposed therebetween, the counterbalance valve being adapted to direct the meter-out flow of fluid from the second port of the actuator to the tank.

8. The hydraulic actuator system of claim 7, wherein the counterbalance valve comprises a pilot-to-open valve, the pilot-to-open valve being in fluid communication with the main directional control valve via a pilot line that is in fluid communication with the fluid communication between the main directional control valve and the first check valve and that is adapted to divert a pilot flow of fluid from the meter-in flow of fluid to the pilot-to-open valve.

9. The hydraulic actuator system of claim 7, wherein the check valve comprises a first check valve and the counterbalance valve comprises a first counterbalance valve, the secondary valve further comprising a second check valve and a second counterbalance valve, wherein the second check valve of the secondary valve is in fluid communication with the second port of the actuator and the main directional control valve such that the check valve is interposed therebetween, the second check valve being adapted to direct the meter-in flow from the main directional control valve to the second port of the actuator, and wherein the second counterbalance valve is in fluid communication with the first port of the actuator and the tank such that the second counterbalance valve is interposed therebetween, the second counterbalance valve being adapted to direct the meter-out flow of fluid from the first port of the actuator to the tank.

10. The hydraulic actuator system of claim 9, further comprising:
first and second secondary supply lines, the first secondary supply line fluidly coupling the main directional control valve to the first check valve of the secondary valve, and the second secondary supply line fluidly coupling the main directional control valve to the second check valve of the secondary valve;
wherein the main direction control valve is adapted to selectively direct the meter-in flow of fluid via the first secondary supply line through the first check valve to the first port of the actuator and to selectively direct the meter-in flow of fluid via the second secondary supply line through the second check valve to the second port of the actuator.

11. The hydraulic actuator system of claim 10, wherein the main directional control valve comprises a plurality of valves adapted to selectively direct the meter-in fluid through the first and second secondary supply lines to the secondary valve.

12. The hydraulic actuator system of claim 11, wherein the main directional control valve comprises a plurality of flow control valves, each flow control valve including a load sense port.

13. The hydraulic actuator system of claim 11, wherein the main directional control valve comprises a plurality of flow control valves, each flow control valve including a post-compensator.

14. The hydraulic actuator system of claim 11, wherein the main directional control valve comprises a pre-compensated valve.

15. The hydraulic actuator system of claim 1, wherein the secondary valve comprises a first secondary valve, and the actuator comprises a first actuator, the system further comprising:
a second secondary valve and a second actuator;
wherein the second secondary valve is in fluid communication with the main directional control valve such that the main directional control valve is interposed between the second secondary valve and the pump, the main directional control valve being adapted to selectively direct the meter-in flow of fluid from the pump to the second secondary valve;
the second secondary valve in fluid communication with the main directional control valve and the second actuator such that the secondary valve is interposed between the main directional control valve and the second actuator, the second secondary valve being adapted to direct the meter-in flow of fluid from the main directional control valve to the second actuator;
the second secondary valve in fluid communication with the second actuator and the tank such that the second secondary valve is interposed between the second actuator and the tank, the second secondary valve being adapted to receive a meter-out flow of fluid from the second actuator and to direct the meter-out flow of fluid to the tank, the fluid communication of the second actuator with the tank via the second secondary valve being configured such that the meter-out flow of fluid from the second actuator is communicated to the tank without passing through the main directional control valve.

16. The hydraulic actuator system of claim 15, wherein the main directional control valve is adapted to independently supply the meter-in flow of fluid to the first and second secondary valves.

17. The hydraulic actuator system of claim 15, wherein the main directional control valve is adapted to supply the meter-in flow of fluid to the first and second secondary valves simultaneously.

18. A method of controlling a hydraulic actuator comprising:
conveying a meter-in flow of fluid from a supply of fluid in a tank to a main directional control valve;
selectively directing the meter-in flow of fluid from the main directional control valve to a secondary valve;
directing the meter-in flow of fluid from the secondary valve to the hydraulic actuator;
directing a meter-out flow of fluid from the hydraulic actuator to the secondary valve; and
directing the meter-out flow of fluid from the secondary valve to the tank via a return flow path without passing through the main directional control valve.

19. The method of claim 18, wherein the return flow path is defined by a secondary tank line that directly fluidly connects the secondary valve to the tank.

20. The method of claim 19, wherein the meter-in flow of fluid comprises a first meter-in flow of fluid, the secondary valve comprises a first secondary valve, and the hydraulic actuator comprises a first actuator, the method further comprising
selectively directing a second meter-in flow of fluid from the main directional control valve to a second secondary valve;
directing the second meter-in flow of fluid from the second secondary valve to a second hydraulic actuator;
directing a second meter-out flow of fluid from the second hydraulic actuator to the second secondary valve; and
directing the second meter-out flow of fluid from the second secondary valve to the tank without directing the second meter-out flow of fluid through the main directional control valve.
